(19) United States
(12) Patent Application Publication
(10) Pub. No.: US 2026/0181047 A1
(43) Pub. Date: Jun. 25, 2026

(54) AUTOENCODER MAPPING

(71) Applicant: Telefonaktiebolaget LM Ericsson (publ), Stockholm (SE)

(72) Inventors: Illyyne SAFFAR, Le plessis-Robinson (FR); Abdulrahman ALABBASI, Kista (SE); Aurelie BOISBUNON, Massy (FR); Maxime BOUTON, Stockholm (SE); Athanasios KARAPANTELAKIS, Solna (SE); Konstantinos VANDIKAS, Solna (SE); Hamed FARHADI, Stockholm (SE)

(73) Assignee: Telefonaktiebolaget LM Ericsson (publ), Stockholm (SE)

(21) Appl. No.: 19/127,498

(22) PCT Filed: Jan. 25, 2023
(86) PCT No.: PCT/SE2023/050062

§ 371 Date: May 6, 2025

(30) Foreign Application Priority Data
Nov. 7, 2022 (GR) 20220100910

(51) Int. Cl. H04L 67/12

(52) U.S. Cl. CPC H04L 67/12

(57) ABSTRACT

A method performed by a first network node is provided. The first network node includes a decoder of a first autoencoder. The method comprises receiving first encoded data. The first encoded data was transmitted by a second network node, and the first encoded data was generated using an encoder of a second autoencoder. The encoder of the second autoencoder is included in the second network node. The method also comprises converting the first encoded data into first converted-encoded data, thereby mapping output of the encoder of the second autoencoder to output of the encoder of the first autoencoder; and decoding the first converted-encoded data using the decoder of the first autoencoder. The first autoencoder and the second autoencoder are different.

### TECHNICAL FIELD

This disclosure relates to autoencoder mapping.

### BACKGROUND

The Third Generation Partnership Project (3GPP) prescribes the use of Artificial Intelligence (AI)/Machine Learning (ML) algorithms including autoencoders (AEs) for Channel State Information (CSI) feedback enhancements across radio channel. AE-based methods for CSI feedback enhancements have been the most popular approaches for the release-18 study. AE-based solutions for CSI compression have been proven to work better than Type II-CSI approaches documented in Release 16, resulting in less overhead for the uplink control interface, and less reconstruction loss, as discussed in references [1] and [2] provided near the end of this disclosure. FIG. 11 shows performance of AE-based solutions versus Rel 16 Type II-CSI. Note that the “Explicit CSI” shown in FIG. 11 is an ideal case of perfect CSI to the radio scheduler. The closer the solutions are to that curve, the better the solutions are.

### SUMMARY

Certain challenges presently exist.

An autoencoder is a neural network (NN) composed of an encoder for compressing original data and a decoder for reconstructing the original data from the compressed data. The encoder and the decoder corresponding to a single autoencoder are generally trained simultaneously, and thus they are trained to perform the best together. This means that an encoder of one autoencoder may not work well with a decoder of another autoencoder because the decoder of another autoencoder is likely different from the decoder of one autoencoder (which is trained to work best with the encoder of the same autoencoder). There are many reasons why the decoders of two different autoencoders are different. For example, the decoders of two autoencoders may have different architectures (e.g., they may have different number of NN layers, different number of input nodes for the NN layers, etc.) or may have the same architecture but may be trained using different training data.

For the reason provided above, it is best to use an encoder of an autoencoder with a decoder of the same autoencoder. However, in many use cases, the autoencoder corresponding to the encoder used for compressing original data is different from the autoencoder corresponding to the decoder for reconstructing the original data.

For example, since the manufacturer of a mobile phone is generally different from a network provider for providing a wireless network for the mobile phone, the autoencoder for the mobile phone is generally different from the autoencoder provided by the network provider (e.g., the autoencoder provided at a base station). Then, the encoder of the mobile phone would not work well with the decoder of the autoencoder provided by the network provider (e.g., in case the encoder of the mobile phone is used for compressing original video data and the decoder provided by the network provider is used for reconstructing the original video data from the compressed data).

Thus, there is a need to adopt (synchronize) autoencoders developed from multiple UE vendors and multiple NW vendors. However, as described in reference [2] which is provided near the end of this disclosure, there are several challenges toward the adoption of different autoencoders developed from multiple UE and NW vendors. These challenges arise from the necessity to share training data (such that the autoencoders are trained using the same training data, thereby being configured to output same compressed data for same input data or same reconstructed data for same compressed data) and/or AE architectures. The challenges can be summarized as below:

Challenge 1: The first challenge occurs when vendors do not want to share their training data (i.e., the data used for training their autoencoders) and/or their NN models corresponding to their autoencoders because the training data and/or the NN models are their proprietary data. One way to resolve this issue is the vendors sharing their proprietary data only partially. For example, UE-vendors may share a part of their autoencoders (e.g., their encoders) with gNB-vendors. In another example, gNB-vendors may share a part of their autoencoders (e.g., their decoders) with UE-vendors. However partially sharing is not the most suitable way to optimize data compression (e.g., CSI data compression) in an end-to-end manner since UE-vendor and gNB-vendor autoencoders are trained on different data. Thus, by sharing encoders only and/or decoders only, channel data cannot be compressed with a minimum overhead or original channel data cannot be reconstructed with a minimum reconstruction error.

Challenge 2: The second challenge is about a case where a common real/synthetic data is shared between NW vendors and UE vendors, but each vendor's autoencoder(s) are kept proprietary. In this case, the challenge is how to ensure interoperability between two separately trained encoders and decoders and/or how to train (or tune) encoders and decoders over the air.

Challenge 3: In order to resolve the compatibility issue, UE vendors can design various encoders that work well with various decoders designed by different NW vendors (Alternatively, NW vendors can design their decoders such that their decoders work well with various encoders designed by different UE vendors). In this case, a UE vendor will have to design a lot of encoders, one per a NW decoder designed by a NW vendor, (or the NW vendor has to design one decoder per a UE encoder designed by UE vendor), which increases UE hardware complexity (or NW hardware complexity). Similarly, there may be a scenario where a NW vendor must maintain different decoders to decode signals from different UE radio chipset vendors.

Therefore, there is a need to align output data (a.k.a., latent space) from an encoder (and/or a decoder) of one autoencoder to output data from an encoder (and/or a decoder) of a different autoencoder without sharing data or sharing any part of the autoencoders that were trained differently.

Accordingly, in one aspect of the embodiments of this disclosure, there is provided a method performed by a first network node. The first network node includes a decoder of a first autoencoder. The method comprises receiving first encoded data. The first encoded data was transmitted by a second network node, and the first encoded data was generated using an encoder of a second autoencoder. The encoder of the second autoencoder is included in the second network node. The method further comprises converting the first encoded data into first converted-encoded data, thereby mapping output of the encoder of the second autoencoder to output of the encoder of the first autoencoder. The method further comprises decoding the first converted-encoded data using the decoder of the first autoencoder, wherein the first autoencoder and the second autoencoder are different.

In another aspect, there is provided a computer program comprising instructions which when executed by processing circuitry cause the processing circuitry to perform the method of any one of the embodiments above.

In another aspect, there is provided a carrier containing the computer program of the above embodiment, wherein the carrier is one of an electronic signal, an optical signal, a radio signal, and a computer readable storage medium.

In another aspect, there is provided a first network node. The first network node including a decoder of a first autoencoder. The first network node is configured to: receive first encoded data, wherein the first encoded data was transmitted by a second network node, and further wherein the first encoded data was generated using an encoder of a second autoencoder, further wherein the encoder of the second autoencoder is included in the second network node. The first network node is further configured to convert the first encoded data into first converted-encoded data, thereby mapping output of the encoder of the second autoencoder to output of the encoder of the first autoencoder. The first network node is further configured to decode the first converted-encoded data using the decoder of the first autoencoder, wherein the first autoencoder and the second autoencoder are different.

In another aspect, there is provided an apparatus. The apparatus comprises a memory; and processing circuitry coupled to the memory, wherein the apparatus is configured to perform the method of any one of the above embodiments.

Embodiments of this disclosure allow aligning autoencoders developed from multiple UE vendors and/or multiple NW vendors while protecting proprietary aspect of the autoencoders. The proprietary aspect of the autoencoders can be protected by (1) not having to share training data with other vendors (either chipset or network) and (2) not having to share the trained model(s) with other vendors (only the latent spaces are shared). Also, by removing the need for switching between pairs of split encoders/decoders in UEs and gNBs in a multi-vendor context (assuming that every pair of the split autoencoder is a vendor specific), less computation time and less resource are needed. Lastly, since one AE can be mapped to various different AEs merely by using different mapping functions, there is no need to switch between pairs of split encoders/decoders in UEs and gNBs, and thus is less expensive.

### BRIEF DESCRIPTION OF THE DRAWINGS

The accompanying drawings, which are incorporated herein and form part of the specification, illustrate various embodiments.

FIG. 1A shows a system according to some embodiments.

FIG. 1B shows an autoencoder architecture.

FIG. 2A shows an autoencoder for a user equipment.

FIG. 2B shows an autoencoder for a base station.

FIG. 2C shows an apparatus according to some embodiments.

FIG. 3 illustrates a mapping from a source latent space to a target latent space.

FIGS. 4A-4D illustrate how domain adaptation are applied to multi-vendor scenarios.

FIG. 5A illustrates symmetric heterogeneous domain adaptation according to some embodiments.

FIG. 5B illustrates asymmetric heterogeneous domain adaptation according to some embodiments.

FIG. 6 shows a process according to some embodiments.

FIG. 7 shows a process according to some embodiments.

FIG. 8 shows a process according to some embodiments.

FIG. 9 shows an apparatus according to some embodiments.

FIG. 10 shows a process according to some embodiments.

FIGS. 11A and B show performance of AE-based solutions versus Release 16 Type II-CSI.

### DETAILED DESCRIPTION

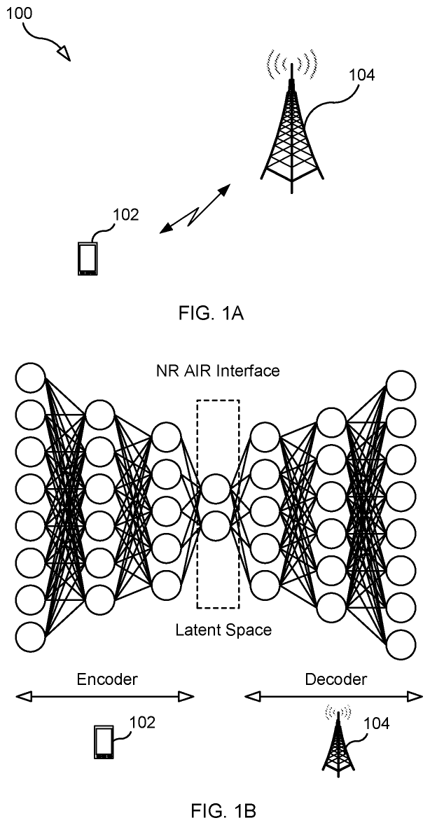

FIG. 1A shows a part of a wireless network system 100 according to some embodiments. Wireless network system 100 comprises a UE 102 and a base station 104. Base station 104 may be configured to transmit reference signal(s) towards UE 102, and UE 102 may be configured to receive the reference signal(s) (e.g., channel state information (CSI) reference signals) transmitted by base station 104. Upon receiving the reference signal(s), UE 102 may transmit towards base station 104 reference signal (RS) report (e.g., CSI report/feedback) indicating the quality of the reference signal(s) received at UE 102 and/or the quality of the channel used for carrying the reference signal(s) from base station 104 to UE 102.

In some scenarios, the size of data corresponding to the RS report (RS report data) may be huge, and thus there may be a need to reduce the size of the RS report data when UE 102 transmits the RS report data to base station 104. One way of addressing the size problem is using an autoencoder.

FIG. 1B shows an example of an autoencoder architecture according to some embodiments. As shown in FIG. 1B, the autoencoder architecture comprises a neural network (NN). A part of the NN corresponds to an encoder included in UE 102 and another part of the NN corresponds to a decoder included in base station 104. The encoder included in UE 102 is configured to encode (compress) input data received at the encoder, thereby generating encoded data. The decoder included in base station 104 is configured to decode the encoded data, thereby reconstructing the input data.

As explained above, the part of the NN corresponding to an encoder of an autoencoder and the part of the NN corresponding to a decoder of an autoencoder are generally trained together. For example, the encoder of UE 102 is generally trained with the decoder of UE 102 (or the decoder provided by the maker of UE 102). Similarly, the encoder of base station 104 is generally trained with the decoder of base station 104 (or the decoder provided by the maker of base station 104). This means that the encoder of UE 102 is configured to work best with the decoder of UE 102 (or the decoder provided by the maker of UE 102). In other words, the decoder of UE 102 is more likely to generate output data that is similar to the original data based on encoded data when the encoded data is encoded by the encoder of UE 102. Thus, the decoder of UE 102 is less likely to generate output data that is similar to the original data based on encoded data when the encoded data is encoded by a different encoder (e.g., the encoder of base station 104).

In order to solve the above problem, according to some embodiments, the latent space (e.g., the encoded data outputted from the encoder) of one autoencoder is mapped/projected to the latent space of another autoencoder.

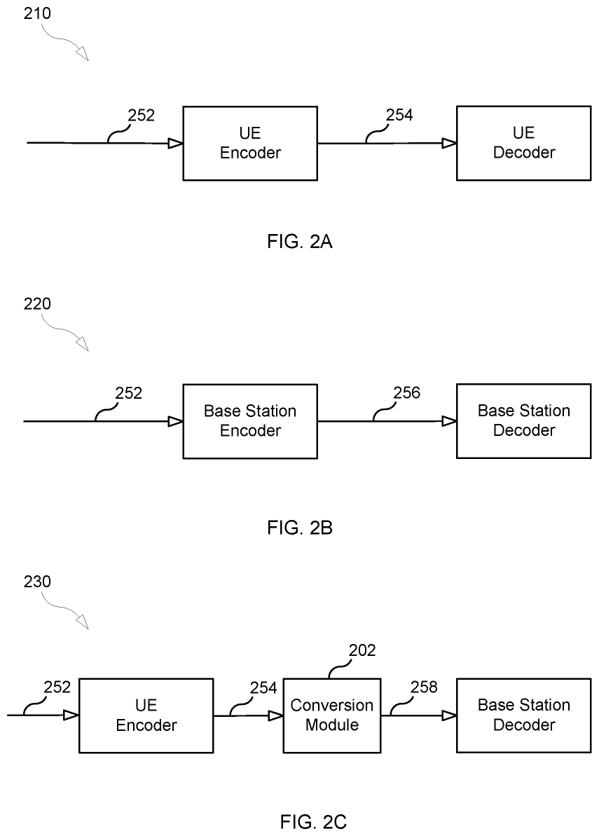

FIG. 2A shows an autoencoder 210 made by a UE vendor. Autoencoder 210 comprises a UE encoder and a UE decoder. The UE encoder is configured to encode input data 252, thereby generating encoded data 254. The UE decoder is configured to decode encoded data 254, thereby reconstructing input data 252 (i.e., generating input data 252 or generating data that is similar to input data 252).

FIG. 2B shows an autoencoder 220 made by a base station vendor. Autoencoder 220 comprises a base station encoder and a base station decoder. The base station encoder is configured to encode input data 252, thereby generating encoded data 256. The base station decoder is configured to decode encoded data 256, thereby reconstructing input data 252 (i.e., generating input data 252 or generating data that is similar to input data 252).

As shown in FIGS. 1B and 2C, there may be a scenario where the UE encoder and the base station decoder are used together. More specifically, there may be a scenario where the UE encoder encodes input data 252, thereby generating encoded data 254, and the base station decoder reconstructs input data 252 by decoding encoded data 254. However, as discussed above, in order for the base station decoder to reconstruct input data 252 well, it is desirable to decode encoded data 256 (encoded by the base station encoder) than encoded data 254 (encoded by the UE encoder).

Therefore, according to some embodiments, a conversion module 202 is provided. This conversion module 202 is configured to map the latent space of the UE autoencoder to the latent space of the base station autoencoder. More specifically, this conversion module 202 is configured to convert encoded data 254 outputted by the UE encoder into encoded data 256 (or data that is similar to encoded data 256) such that encoded data 256 (not encoded data 254) is provided to the base station decoder. By decoding encoded data 256 rather than encoded data 254, the base station decoder can reconstruct input data 252 better.

Since this projection or mapping requires sharing only the latent spaces (i.e., encoded data 254 and/or 256) between UE(s) and network vendor(s) (which is already shared over the air via New Radio air interface shown in FIG. 1B), it removes the need of sharing NN(s) corresponding to autoencoder(s) or training data for the NN(s).

This projection or mapping (herein after, “mapping”) is based on a machine learning technique and more precisely on transfer learning and domain adaptation. The mapping comprises transferring knowledge learned in one or several settings (e.g., autoencoders from UE vendors) to another settings (e.g., autoencoders from NW vendors) that share similarities but not the exact same distribution. The differences between the two settings may come from the fact that each autoencoder can have a different architecture, a different objective (e.g., high performance, or a trade-off between performance and complexity of the architecture), or even that the autoencoders were trained on different training datasets.

Detailed information about mapping of the source latent space (e.g., encoded data 254) to the target latent space (e.g., encoded data 256) is provided below.

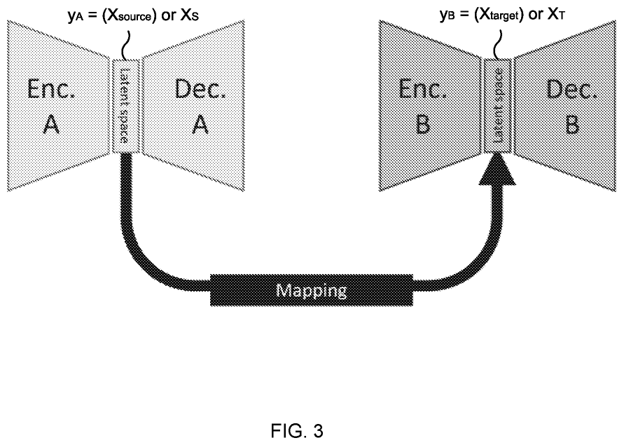

FIG. 3 illustrates a mapping between the source latent space (i.e., the latent space from an autoencoder A) and the target latent space (i.e., the latent space from an autoencoder B). In FIG. 3, y_{A}=X_{source} or X_{S} is the latent space from the autoencoder A, and y_{B}=X_{target} or X_{T} is the latent space from the autoencoder B (i.e., the target). Two data domains for the source and the target with the marginal probabilities—p_{S} and p_{T}—are defined as D_{S}=(X_{S}, P_{S}) and D_{T}=(X_{T}, p_{T}).

Note that, in order to facilitate the mapping of one latent space to another latent space, it is desirable that X_{S} and X_{T} have the same dimension and are built from the same initial inputs (features) that are fed to the autoencoders A and B (e.g., it is desirable that initial input features have the same dimension in the encoder as well as in the decoder). In case where X_{S} and X_{T} do not have the same dimension (and/or where the initial inputs (features) don't have the same dimension), a technique from a subfield of domain adaptation called heterogenous domain adaptation can be used. However, it is much more complicated to ensure its quality/accuracy when X_{S} and X_{T} do not have the same dimension (and/or where the initial inputs (features) don't have the same dimension).

Referring back to FIG. 3, the problem is finding and applying a function mapping, aligning, or projecting (herein after, just “mapping”) X_{S} to X_{T} (e.g., how to align D_{S} and D_{T}, which falls in the area of unsupervised domain adaptation), thereby reducing the mismatch between the latent spaces X_{S} and X_{T} (or latent distributions) of the encoder and the decoder (or of two autoencoders coming from different trained networks) without sharing any training data or any parts of NNs corresponding to the autoencoders.

There are many different ways of performing the mapping of the source latent space X_{S} to the target latent space X_{T}. Examples of the ways of performing the mapping are the followings:

### 1. Subspace Alignment

In some embodiments, the mapping of the source latent space X_{S} to the target latent space X_{T} may be performed based on subspace alignment.

For example, according to some embodiments, both latent spaces X_{S} and X_{T} may be projected into a common shared subspace such that a common representation of both the source and target latent spaces can be found. This technique is not the most optimal solution as it exploits only part of the features in each domain (target and source). But it is the easiest approach.

In another example, according to some embodiments, the source latent space X_{S} is projected into the target latent space X_{T}. A linear transformation may be learned to map the source space to the target space. Basis vectors may be aligned by using a transformation matrix M from X_{S} to X_{T} (M∈ [symbol] ^{d×d}), where d is the dimensions of both X_{S} and X_{T}. M may be learned by minimizing the Bregman matrix divergence:

$${M}^{*} = arg {min}_{M} ( F ( M ) ) with F ( M ) = {‖ {X}_{s} M - {X}_{T} ‖}_{F}^{2} , where {‖ . ‖}_{F}^{2}$$

is the Frobenius norm, and M* is the optimal matrix mapping the source space to the target space.

### 2. Optimal Transport

In some embodiments, the mapping of the source latent space X_{S} to the target latent space X_{T} may be performed based on optimal transport.

Optimal transport was initially introduced by Monge in 1781 to optimize the resource allocation by minimizing the transport cost from a set of factories to a set of mines. More formally, let Ω⊆ [symbol] ^{d} be a space and P(Ω) be the set of all probability measures over Ω. Given two probability measures μ and μ′∈P(Ω), the Monge-Kantorovich problem consists in finding a probabilistic coupling γ defined as a joint probability measure over Ω×Ω with marginals μ and μ′┘x, y∈Ω that minimizes the cost of transport regarding some function c, as described in Reference [5].

In optimal transport domain adaptation, the goal is finding an alignment that minimizes the cost of transportation between two distributions. According to optimal transport theory, there exists a transport T that pushes the source domain to the target domain.

In some embodiments, the optimal transport domain adaptation can be based on Knothe-Rosenblatt theorem (which is described in Reference [7]). For example, let μ and v be two probability measures on [symbol] and their cumulative distribution functions (CDF) be respectively:

$$F ( x ) = {\int }_{- ∞}^{x} d μ and G ( x ) = {\int }_{- ∞}^{x} d v .$$

Also let T be a transport mapping such that: T=G⁻¹∘F with G⁻¹(t)=inf{x∈ [symbol] : G(x)>t}. If x˜μ then T(x)˜v. (Which is often denoted through the push-forward notation T_{#}μ=v).

Using such implementation is totally unsupervised, thus the vendors don't need to share any data or partial/total architectures of their AE. However, this method may be very consuming.

In other embodiments, the optimal transport domain adaptation can be based on Joint distribution optimal transport (based on Monge-Kantorovich theorem) described in Reference [6]. Alternatively, the optimal transport domain adaptation can be based on the optimal transport, as described in Reference [4].

### 3. Marginal Distance Alignment

In some embodiments, the mapping of the source latent space X_{S} to the target latent space X_{T} may be performed based on marginal distance alignment. Marginal distance alignment process may comprise the following steps:
Step 1) Computing an estimate of the empirical probability distribution function ƒ(X_{S}) using the collected measurements from the source latent space (i.e., the latent space of the autoencoder A).
Step 2) Determine a set of parameters (a₁, . . . , a_{N}) of a parametric mapping function T as follows.
Step 2-1) Initiate the mapping function T with initial parameters (a₁, . . . , a_{N})=(â₁, . . . , â_{N}).
Step 2-2) Apply the mapping function T to the measurements from the latent space of autoencoder A (i.e., the source latent space).
Step 2-3) Compute an estimate of the empirical probability distribution function g(X_{T}) using measurements from the mapping of the latent space of autoencoder B (i.e., the target latent space).
Step 2-4) Compute the distance between the probability density functions ƒ(X_{S}) and g(X_{T}) using the Kullback-Leibler divergence measure D_{KL}:

$${D}_{K L} ( f \vert \vert g ) = {\sum }_{x} f ( x ) log ( \frac{f ( x )}{g ( x )} )$$

where a lower value implies a lower distance between the probability distributions and hence better matching of the latent spaces of autoencoder A and autoencoder B (i.e., the source latent space and the target latent space).
Step 2-5) Update the parameters of the mapping function T to minimize the Kullback-Leibler divergence measure between the probability density functions ƒ(x) and g(x) as follows: (a₁, . . . , a_{N})=argmin(D_{KL} (ƒ∥g)).

Steps 2-2 through steps 2-5 are repeated until the computed measure D_{KL}(ƒ∥g) in step 2-4 becomes lower than a first threshold, or the reductions in this measure in subsequent iterations become lower that a second threshold.

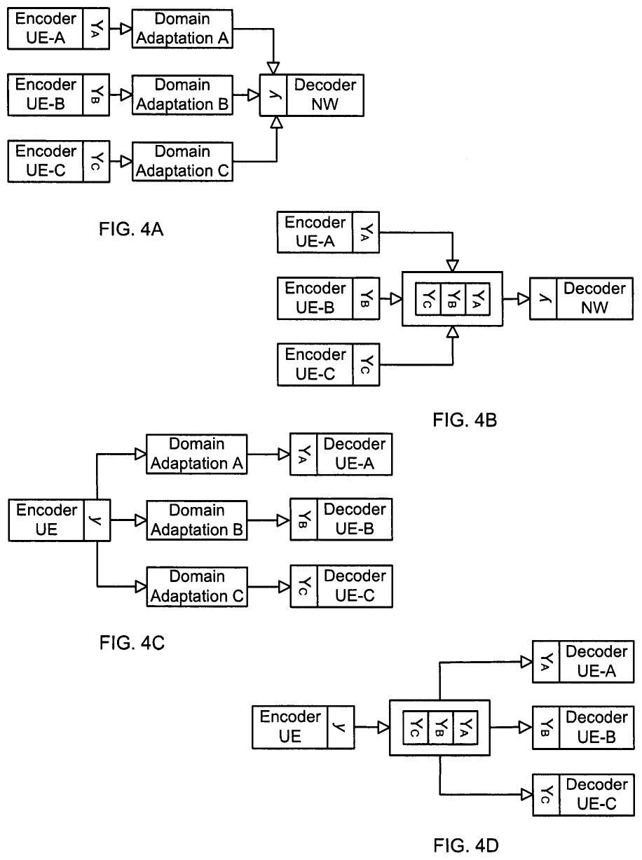

FIG. 4 illustrates embodiments of applying domain adaptation (e.g., subspace alignment, optimal transport, or marginal distance alignment) to cases where multiple vendors (i.e., multiple sources and/or multiple targets) are involved. More specifically, FIGS. 4A and 4B illustrate embodiments of applying domain adaptation to cases where multiple UE vendors and a single network vendor are involved while FIGS. 4C and 4D illustrate embodiments of applying domain adaptation to cases where a single UE vendor and multiple network vendors are involved.

### Multiple UE Vendors & Single Network Vendor

FIG. 4A illustrates embodiments of applying domain adaptation to a multi-UE-vendor and single network vendor scenario in a single source-single target setting. In these embodiments, the domain adaptation (e.g., subspace alignment, optimal transport, or marginal distance alignment) is learned and applied for each UE vendor to the same network vendor.

For example, a first mapping function may be used to map the source latent space for UE-A to the target latent space for NW, a second mapping function may be used to map the source latent space for UE-B to the target latent space for NW, and a third mapping function may be used to map the source latent space for UE-C to the target latent space for NW.

In some embodiments, a group of two or more UE vendors having similar source data distributions can be grouped/clustered together, and a single domain adaptation can be learned and applied between the group of similar UE vendors and the same network vendor. For example, in case the source data distributions of UE-A and UE-B are similar, UE-A and UE-B may be grouped as a single group and the same domain adaptation may be learned and applied between the group and the network vendor.

FIG. 4B illustrates embodiments of applying domain adaptation to a multi-UE-vendor and single network vendor scenario in multi sources-single target setting. In these embodiments, the domain adaptation (e.g., subspace alignment, optimal transport, or marginal distance alignment) is learned and applied for all the UE vendors to the same network vendor. The easiest way to assure this is to concatenate all sources (i.e., UE vendors) and treat them as a single source despite the differences between the source data distributions among the sources. This solution is not very optimal, but it can be faster in the case where there are similarities between sources.

### Single UE Vendor & Multiple Network Vendors

FIG. 4C illustrates embodiments of applying domain adaptation to a single UE vendor and multiple network vendors scenario in a single source-single target setting. In these embodiments, the domain adaptation (e.g., subspace alignment, optimal transport, or marginal distance alignment) is learned and applied between the common UE vendor and each network vendor.

In some embodiments, a group of two or more network vendors having similar target data distributions can be grouped/clustered together, and a single domain adaptation can be learned and applied between the group of similar network vendors and the same UE vendor. For example, in case the target data distributions of the network vendors NW-A and NW-B are similar, NW-A and NW-B may be grouped as a single group and the same domain adaptation may be learned and applied between the group of network vendors and the common UE vendor.

FIG. 4D illustrates embodiments of applying domain adaptation to a single UE vendor and multiple network vendors scenario in a single source-multi target setting. In these embodiments, the domain adaptation (e.g., subspace alignment, optimal transport, or marginal distance alignment) is learned and applied for all the network vendors to the same UE vendor. The easiest way to assure this is to concatenate all targets (i.e., network vendors) and treat them as a single target despite the differences between the targets. This solution is not very optimal, but it can be faster in the case where there are similarities between sources.

In any of the embodiments described above, the algorithm and/or the module for performing the domain adaptation can be implemented the UE side or on the NW side (for resource and privacy reasons).

### Heterogenous Transfer Learning

The embodiments described above are based on the assumptions that (1) the source latent space (e.g., of AE A) and the target latent space (e.g., of AE B) have the same dimensions; (2) the source and target latent spaces are defined by the same features, and (3) the difference between the source latent space and the target latent space is on the probability value distributions of the training/verification datasets.

However, there may be cases where the dimension of the source latent space and the dimension of the target latent space may be different. For example, some vendors may want to encode additional features such as UE power characteristics (e.g., power level, rate of discharge of battery, and/or state of charge), remaining storage, throughput projections, mobility data, etc. The reason is that this information may be of use to the radio scheduler on the network side.

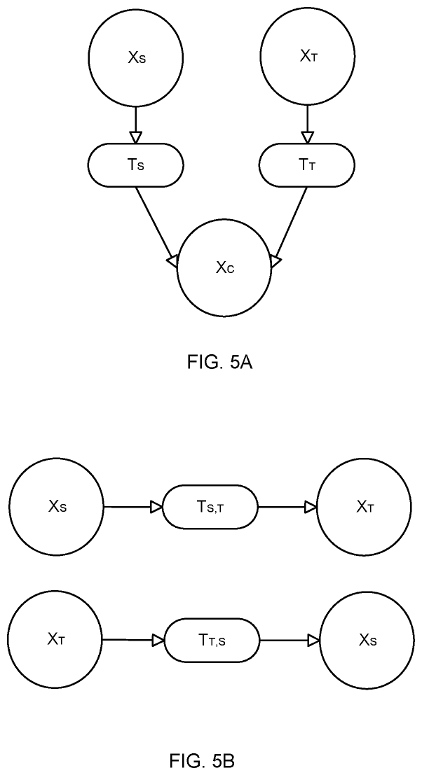

The key to heterogeneous domain adaptation is to learn how to map features of given a source domain X_{S} to a target domain X_{T}. Two sets of approaches may be used for performing the heterogeneous domain adaptation. One set of approaches, known as symmetric heterogeneous domain adaptation, learns transformation functions to create a common domain X_{C} from the source and target domains, as shown in FIG. 5A. Another set of approaches, known as asymmetric domain adaptation, focuses on learning the transformation functions that can transform the source domain to the target domain and vice versa, as shown in FIG. 5B.

As shown in FIG. 5A, in the symmetric approach, a common feature representation is created through the use of transformer functions T_{S} and T_{T} such that X_{C}←T_{S} X_{S} and X_{C}←T_{T} X_{T}. On the contrary, as shown in FIG. 5B, in the asymmetric approach, a transformer function T_{S} is used for transforming the source domain X_{S} to the target domain X_{T} while a different transformer function T_{T} is used for transforming the target domain X_{T} to the source domain X_{S}.

In some scenarios, it may be preferred to use the symmetric approach over the asymmetric approach. For example, as explained above, in the symmetric approach, two transformer functions are used for the domain adaptation—one for transforming X_{S} to X_{C} and another one for transforming Xt to Xc, while, in the asymmetric approach, a single transformer function for transforming Xs to Xt is used for the domain adaptation. In case the difference between Xs and Xc is less than the difference between Xs and Xt, the computational power required for performing the transformation from Xs to Xc would be lower than the computational power required for performing the transformation from Xs to Xt. In such case, if the entity for transforming Xs has relatively low computational power, the symmetric approach is preferred

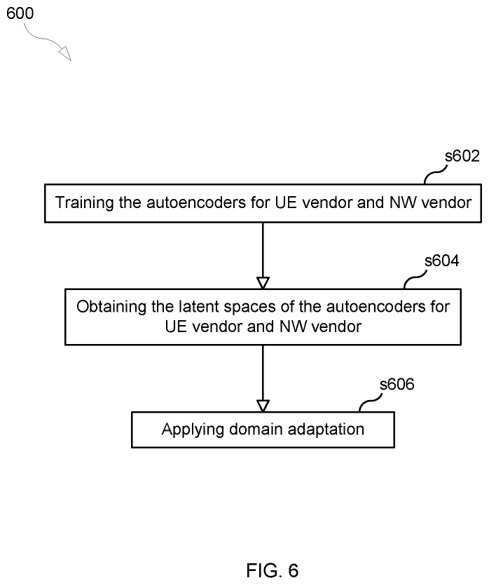

FIG. 6 shows a process 600 for mapping a source latent space to a target latent space, according to some embodiments. Note that even though FIG. 6 shows that process 600 is directed to a single source (e.g., a single UE vendor)-single target (e.g., a single NW vendor) scenario, process 600 is equally applicable to multi-vendor scenarios (e.g., a single source-multi-target scenario (a single UE vendor and multiple NW vendors) or a multi-source-single target scenario (multiple NW vendors and a single UE vendor)).

Process 600 describes the overall process of training phase of the mapping function between autoencoders. It may begin with step s602. Step s602 comprises training the autoencoder for a UE vendor (i.e., the source) and the autoencoder for a NW vendor (i.e., the target). Step s604 comprises collecting or obtaining the latent space (X_{source}) of the autoencoder for the UE vendor and the latent space (X_{target}) of the autoencoder for the NW vendor. Step s606 comprises applying domain adaptation (e.g., subspace alignment, optimal transport, or marginal distance alignment) to the latent spaces such that the source latent space is mapped to the target latent space. More specifically, in step s606, an algorithm/model for mapping the source latent space to the target latent space should be trained using the source latent space (X_{source}) and the target latent space (X_{target}) as the input of the algorithm (e.g., such that the difference between the mapped source latent space and the target latent space is minimized), and the accuracy (performance) of the algorithm/model for the domain adaptation may be evaluated. After the evaluation, the mapping algorithm/model may be deployed.

In case there are multiple NW vendors, according to some embodiments, a common mapping function may be provided. More specifically, in these embodiments, when the source (e.g., UE 102) transmits encoded data, the common mapping function may convert the encoded data differently based on which NW vendor is to receive the converted encoded data and transmit the converted encoded data. For example, the common mapping function may use a combination of the encoded data and an indictor indicating a particular NW vendor (or a decoder or an autoencoder used by the particular NW vendor) as its input and convert the encoded data differently based on the indicator.

In some embodiments, the source (e.g., UE 102) may decide how often the target (e.g., the baseline NW vendors or the non-baseline NW vendors) needs to send to the source information needed for updating the mapping function (e.g., in case updating the mapping function is performed at the source) and/or how often the source needs to send to the target information needed for updating the mapping function (e.g., in case updating the mapping function is performed at the target).

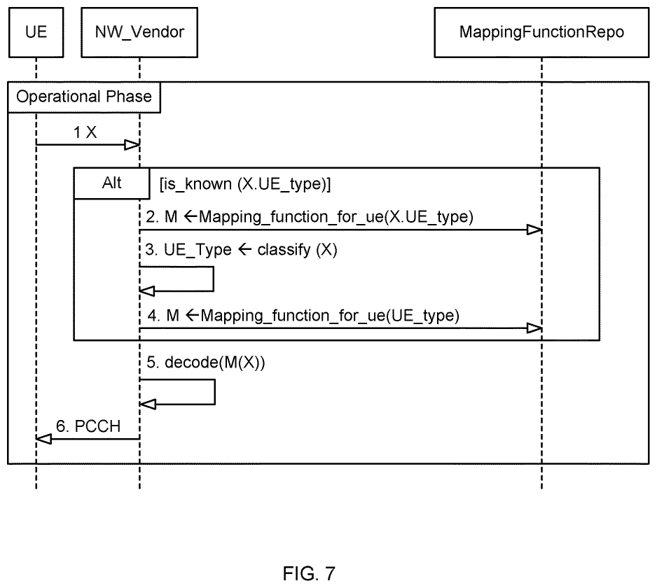

In some embodiments, the mapping function does not need to be communicated to the source (e.g., UE 102). Instead, the mapping function may reside in the target (e.g., base station 104). In such embodiments, as shown in FIG. 7, the source (e.g., UE) may send to the target (e.g., NW-vendor) input data (e.g., encoded data generated based on original input data) (step s702). For every input data received from the source, the target may adjust the input data using the mapping function and send the adjusted input (e.g., converted encoded data) to the decoder to reconstruct the original input data (steps s704 and s706).

In some embodiments, instead of using a mapping function unique to a particular UE, a mapping function for UEs that is similar to the particular UE may be used for performing the mapping. For example, if the type of a particular chipset vendor of a UE is known, a classification model can be used to classify the latent space corresponding to the particular chipset vendor to the most similar chipset vendor and then the mapping function corresponding to the most similar chipset vendor may be used to mapping the latent space of the particular chipset vendor to the latent space of the NW vendor.

In some embodiments, the process of learning one or more mapping functions may be allocated in a cloud-based infrastructure. For example, a mapping function may be generated in a cloud and then may be distributed (e.g., the elements of the function may be copied and distributed) to UE 102 and/or base station 104.

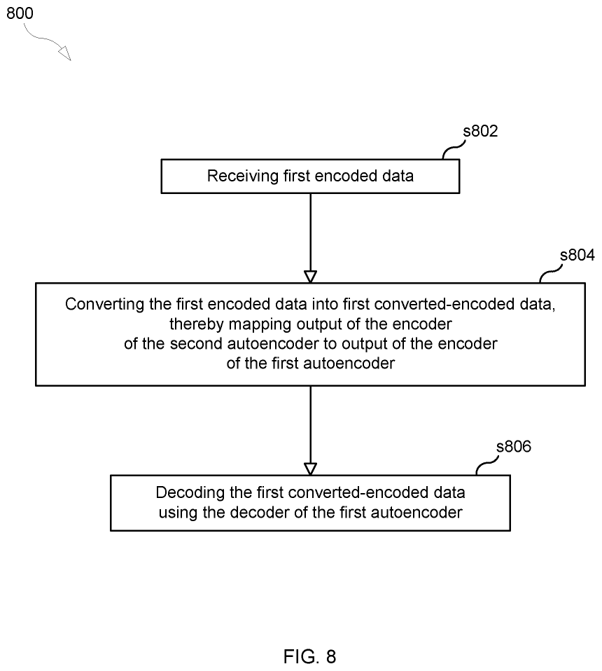

FIG. 8 shows a process 800 performed by a first network node (e.g., 102 or 104) according to some embodiments. The first network node includes a decoder of a first autoencoder. Process 800 may begin with step s802. Step s802 comprises receiving first encoded data. The first encoded data was transmitted by a second network node, and the first encoded data was generated using an encoder of a second autoencoder. The encoder of the second autoencoder is included in the second network node. Step s804 comprises converting the first encoded data into first converted-encoded data, thereby mapping output of the encoder of the second autoencoder to output of the encoder of the first autoencoder. Step s806 comprises decoding the first converted-encoded data using the decoder of the first autoencoder. The first autoencoder and the second autoencoder are different.

In some embodiments, the first encoded data is converted into the first converted-encoded data using a first mapping function, and the first mapping function is determined based on outputs of an encoder of the first autoencoder and of the encoder of the second autoencoder for the same encoded data.

In some embodiments, the encoder of the second autoencoder is configured to generate the first encoded data based on first input data, and the encoder of the first autoencoder is configured to generate different encoded data based on the first input data.

In some embodiments, a difference between the first converted-encoded data and said different encoded data is less than a difference between the first encoded data and said different encoded data.

In some embodiments, process 800 further comprises receiving second encoded data, wherein the second encoded data was transmitted by a third network node, and further wherein the second encoded data was generated using an encoder of a third autoencoder, and further wherein the encoder of the third autoencoder is included in the third network node, converting the second encoded data into second converted-encoded data, thereby mapping output of the encoder of the third autoencoder to output of the encoder of the first autoencoder; and decoding the second converted-encoded data using the decoder of the first autoencoder, wherein the first autoencoder and the third autoencoder are different.

In some embodiments, the second encoded data is converted into the second converted-encoded data using a second mapping function.

In some embodiments, the first mapping function and the second mapping function are different, and the second mapping function is determined based on the performance of the encoder of the first autoencoder and performance of the encoder of the third autoencoder.

In some embodiments, the first mapping function and the second mapping function are the same, and the first mapping function and the second mapping function are determined based on the performance of the encoder of the first autoencoder, the performance of the encoder of the second autoencoder, and performance of the encoder of the third autoencoder.

In some embodiments, the first encoded data is transmitted to a third network node, the third network node includes a decoder of a third autoencoder, and the first mapping function is determined based on the performance of the encoder of the first autoencoder, the performance of the encoder of the second autoencoder, and performance of an encoder of the third autoencoder.

In some embodiments, the input data is channel state information, CSI, report or sounding reference signals, SRS, report.

In some embodiments, the first network node is a base station, and the second network node is a user equipment selected from a group comprising a mobile phone, a tablet, a laptop, a desktop, an Internet of Things, IoT, device, or a vehicle.

In some embodiments, the first network node is a network data analytics function, NWDAF, and the second network node is a remote computing entity at network side.

In some embodiments, the first mapping function is obtained using any one of subspace alignment, optimal transport, or marginal distance alignment.

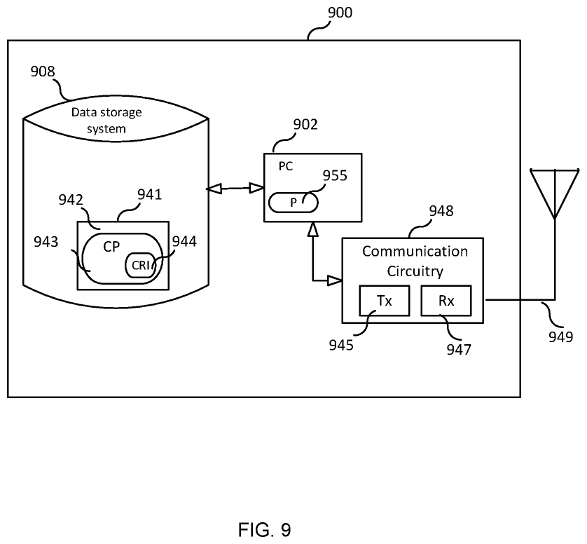

FIG. 9 is a block diagram of UE 102, according to some embodiments. As shown in FIG. 9, UE 102 may comprise: processing circuitry (PC) 902, which may include one or more processors (P) 955 (e.g., one or more general purpose microprocessors and/or one or more other processors, such as an application specific integrated circuit (ASIC), field-programmable gate arrays (FPGAs), and the like); communication circuitry 948, which is coupled to an antenna arrangement 949 comprising one or more antennas and which comprises a transmitter (Tx) 945 and a receiver (Rx) 947 for enabling UE 102 to transmit data and receive data (e.g., wirelessly transmit/receive data); and a local storage unit (a.k.a., “data storage system”) 908, which may include one or more non-volatile storage devices and/or one or more volatile storage devices. In embodiments where PC 902 includes a programmable processor, a computer program product (CPP) 941 may be provided. CPP 941 includes a computer readable medium (CRM) 942 storing a computer program (CP) 943 comprising computer readable instructions (CRI) 944. CRM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes UE 102 to perform steps described herein (e.g., steps described herein with reference to the flow charts). In other embodiments, UE 102 may be configured to perform steps described herein without the need for code. That is, for example, PC 902 may consist merely of one or more ASICs. Hence, the features of the embodiments described herein may be implemented in hardware and/or software.

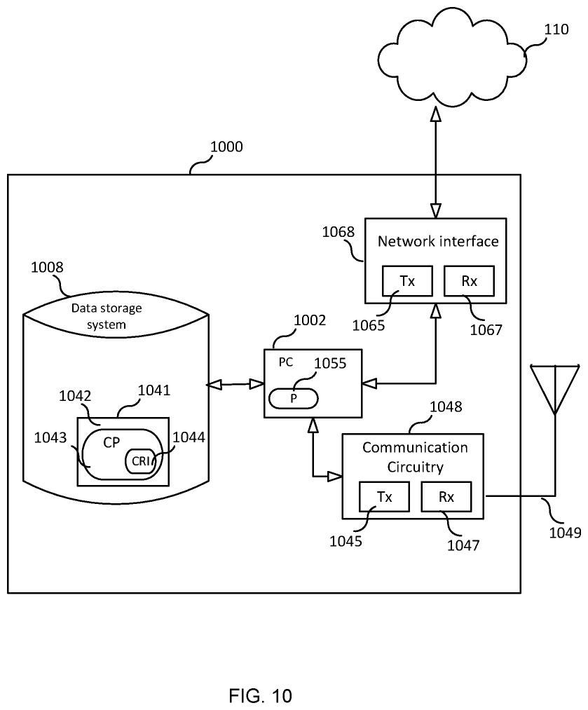

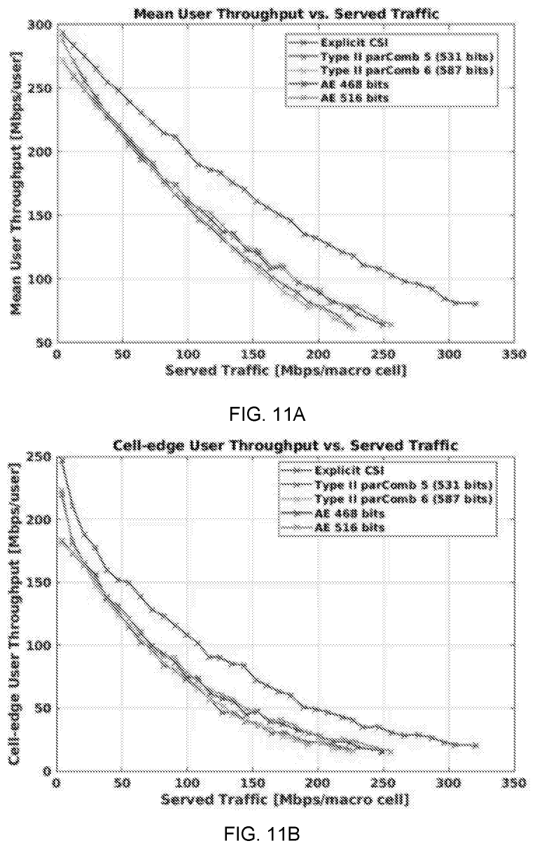

FIG. 10 is a block diagram of base station 104, according to some embodiments. As shown in FIG. 10, base station 104 may comprise: processing circuitry (PC) 1002, which may include one or more processors (P) 1055 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., apparatus 1000 may be a distributed computing apparatus); a network interface 1068 comprising a transmitter (Tx) 1065 and a receiver (Rx) 1067 for enabling apparatus 1000 to transmit data to and receive data from other nodes connected to a network 110 (e.g., an Internet Protocol (IP) network) to which network interface 1048 is connected; communication circuitry 1048, which is coupled to an antenna arrangement 1049 comprising one or more antennas and which comprises a transmitter (Tx) 1045 and a receiver (Rx) 1047 for enabling base station 104 to transmit data and receive data (e.g., wirelessly transmit/receive data); and a local storage unit (a.k.a., “data storage system”) 1008, which may include one or more non-volatile storage devices and/or one or more volatile storage devices. In embodiments where PC 1002 includes a programmable processor, a computer program product (CPP) 1041 may be provided. CPP 1041 includes a computer readable medium (CRM) 1042 storing a computer program (CP) 1043 comprising computer readable instructions (CRI) 1044. CRM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes base station 104 to perform steps described herein (e.g., steps described herein with reference to the flow charts). In other embodiments, base station 104 may be configured to perform steps described herein without the need for code. That is, for example, PC 1002 may consist merely of one or more ASICs. Hence, the features of the embodiments described herein may be implemented in hardware and/or software.

Reference List

| | |
|---|---|
| 1. | STAR AI PHY Feature Team, “Challenges of Multi-Vendor Machine Learning for |
| | the NR Air Interface |
| | https://ericsson.sharepoint.com/:p:/r/sites/ERMIAPatents/_layouts/15/Doc.aspx?sourcedoc=%7BAB05C0CC-7F39-4905-BDED- |
| | 922E746FF711%7D&file=20220323%20ER%20AI%20Challenges%20of%20multi- |
| | vendor%20machine%20learning%20for%20the%20NR%20physical%20layer.pptx&action=edit&mobileredirect=true |
| 2. | 3GPP TSG-RAN WG1, Meeting #109-e, Tdoc R1-2203281, “Evaluation of AI-CSI”, |
| | Online, May 16th-27th, 2022, |
| | https://www.3gpp.org/ftp/tsg_ran/WG1_RL1/TSGR1_109-e/Docs/R1-2203281.zip |
| 3. | Fernando, B., Habrard, A., Sebban, M., & Tuytelaars, T. (2014). Subspace alignment |
| | for domain adaptation. arXiv preprint arXiv: 1409.5241. |
| 4. | Villani, C. (2009). Optimal transport: old and new (Vol. 338, p. 23). Berlin: springer. |
| 5. | Redko, I., Habrard, A., & Sebban, M. (2017, September). Theoretical analysis of |
| | domain adaptation with optimal transport. In Joint European Conference on Machine |
| | Learning and Knowledge Discovery in Databases (pp. 737-753). Springer, Cham. |
| 6. | Courty, N., Flamary, R., Habrard, A., & Rakotomamonjy, A. (2017). Joint |
| | distribution optimal transportation for domain adaptation. Advances in Neural |
| | Information Processing Systems, 30. |
| 7. | Virmaux, Aladin, Illyyne Saffar, Jianfeng Zhang, and Balazs Kegl. “Knothe- |
| | Rosenblatt transport for Unsupervised Domain Adaptation.” arXiv preprint |
| | arXiv: 2110.02716 (2021). |
| 8. | Samat, A.; Persello, C.; Gamba, P.; Liu, S.; Abuduwaili, J.; Li, E. Supervised and |
| | Semi-Supervised Multi-View Canonical Correlation Analysis Ensemble for |
| | Heterogeneous Domain Adaptation in Remote Sensing Image Classification. Remote |
| | Sens. 2017, 9, 337. https://doi.org/10.3390/rs9040337 |
| 9. | Duan L, Xu D, Tsang I. Learning with augmented features for heterogeneous domain |
| | adaptation. 2012. arXiv preprint arXiv: 1206.4660. |
| 10. | Zhou JT, Tsang IW, Pan SJ, Tan M. Heterogeneous domain adaptation for multiple |
| | classes. In: AISTATS. 2014. p. 1095-1103. |
| 11. | Feuz KD, Cook DJ. Transfer learning across feature-rich heterogeneous feature |
| | spaces via feature-space remapping (FSR). ACM Trans Intell Syst Technol. 2015; 6:3 |

Abbreviations

| | |
|---|---|
| NW | Network |
| UE | User Equipment |
| ML | Machine Learning |
| DA | Domain Adaptation |
| eNB | Evolved Node B |
| gNB | Next generation nodeB |
| IvD | Invention Disclosure |
| TL | Transfer Learning |
| OT | Optimal Transport |
| SA | Subspace Alignment |
| AE | Autoencoder/AutoEncoder |
| CSI | Channel State Information |

1. A method performed by a first network node, the first network node including a decoder of a first autoencoder, the method comprising:
receiving first encoded data, wherein the first encoded data was transmitted by a second network node, and further wherein the first encoded data was generated using an encoder of a second autoencoder, further wherein the encoder of the second autoencoder is included in the second network node;
converting the first encoded data into first converted-encoded data, thereby mapping output of the encoder of the second autoencoder to output of the encoder of the first autoencoder; and
decoding the first converted-encoded data using the decoder of the first autoencoder, wherein
the first autoencoder and the second autoencoder are different.

2. The method of claim 1, wherein
the first encoded data is converted into the first converted-encoded data using a first mapping function, and
the first mapping function is determined based on outputs of an encoder of the first autoencoder and of the encoder of the second autoencoder for the same encoded data.

3. The method of claim 2, wherein
the encoder of the second autoencoder is configured to generate the first encoded data based on first input data, and
the encoder of the first autoencoder is configured to generate different encoded data based on the first input data.

4. The method of claim 3, wherein a difference between the first converted-encoded data and said different encoded data is less than a difference between the first encoded data and said different encoded data.

5. The method of claim 1, wherein the method further comprises:
receiving second encoded data, wherein the second encoded data was transmitted by a third network node, and further wherein the second encoded data was generated using an encoder of a third autoencoder, and further wherein the encoder of the third autoencoder is included in the third network node,
converting the second encoded data into second converted-encoded data, thereby mapping output of the encoder of the third autoencoder to output of the encoder of the first autoencoder; and
decoding the second converted-encoded data using the decoder of the first autoencoder, wherein
the first autoencoder and the third autoencoder are different.

6. The method of claim 5, wherein the second encoded data is converted into the second converted-encoded data using a second mapping function.

7. The method of claim 6, wherein
the first mapping function and the second mapping function are different, and
the second mapping function is determined based on the performance of the encoder of the first autoencoder and performance of the encoder of the third autoencoder.

8. The method of claim 6, wherein
the first mapping function and the second mapping function are the same, and
the first mapping function and the second mapping function are determined based on the performance of the encoder of the first autoencoder, the performance of the encoder of the second autoencoder, and performance of the encoder of the third autoencoder.

9. The method of claim 2, wherein
the first encoded data is transmitted to a third network node,
the third network node includes a decoder of a third autoencoder, and
the first mapping function is determined based on the performance of the encoder of the first autoencoder, the performance of the encoder of the second autoencoder, and performance of an encoder of the third autoencoder.

10. The method of claim 1, wherein the input data is channel state information report or sounding reference signals report.

11. The method of claim 1, wherein
the first network node is a base station, and
the second network node is a user equipment selected from a group comprising a mobile phone, a tablet, a laptop, a desktop, an Internet of Things device, or a vehicle.

12. The method of claim 1, wherein
the first network node is a network data analytics function, NWDAF, and
the second network node is a remote computing entity at network side.

13. The method of claim 2, wherein the first mapping function is obtained using any one of subspace alignment, optimal transport, or marginal distance alignment.

14. A non-transitory computer readable storage medium storing a computer program comprising instructions which when executed by processing circuitry of an apparatus causes the apparatus to perform the method of claim 1.

15. (canceled)

16. A first network node, the first network node comprising a decoder of a first autoencoder, the first network node being configured to perform a method comprising:
receiving first encoded data, wherein the first encoded data was transmitted by a second network node, and further wherein the first encoded data was generated using an encoder of a second autoencoder, further wherein the encoder of the second autoencoder is included in the second network node;
converting the first encoded data into first converted-encoded data, thereby mapping output of the encoder of the second autoencoder to output of the encoder of the first autoencoder; and
decoding the first converted-encoded data using the decoder of the first autoencoder, wherein
the first autoencoder and the second autoencoder are different.

17. The first network node of claim 16, wherein
the first encoded data is converted into the first converted-encoded data using a first mapping function, and
the first mapping function is determined based on outputs of an encoder of the first autoencoder and of the encoder of the second autoencoder for the same encoded data.

18. The first network node of claim 16, wherein the method further comprises:
receiving second encoded data, wherein the second encoded data was transmitted by a third network node, and further wherein the second encoded data was generated using an encoder of a third autoencoder, and further wherein the encoder of the third autoencoder is included in the third network node,
converting the second encoded data into second converted-encoded data, thereby mapping output of the encoder of the third autoencoder to output of the encoder of the first autoencoder; and
decoding the second converted-encoded data using the decoder of the first autoencoder, wherein
the first autoencoder and the third autoencoder are different.
